(19) United States
(12) Patent Application Publication
(10) Pub. No.: US 2024/0430158 A1
(43) Pub. Date: Dec. 26, 2024

(54) CLUSTERED SERVERS FOR TELECOMMUNICATIONS

(71) Applicant: MICROSOFT TECHNOLOGY LICENSING, LLC, Redmond, WA (US)

(72) Inventors: Ian Ranulf HANAHOE, London (GB); Thomas Paul WHITEWAY, London (GB); Josephine Julie ADKIN, Exeter (GB); Steven BIGGS, London (GB)

(21) Appl. No.: 18/236,394

(22) Filed: Aug. 21, 2023

(30) Foreign Application Priority Data
Jun. 21, 2023 (GB) 2309364.4

(51) Int. Cl. H04L 41/0816; H04L 67/1001

(52) U.S. Cl. CPC H04L 41/0816; H04L 67/1001

(57) ABSTRACT

A query for a subscriber is received, and in response to determining that configuration data associated with the subscriber is on a failed node of a clustered AS, a method comprises: determining a healthy node; requesting the healthy node to instantiate a configuration block associated with the subscriber and, in response to the block being a child block, a first parent block upon which the child block is dependent; receiving a response that an identifier associated with the subscriber has been registered on the healthy node; responding to the query with the location of the healthy node; after receiving the response, adding at least one configuration block on the failed AS node, excluding any configuration block that was requested to be instantiated, to a queue for requesting the healthy node to instantiate each configuration block of the queue.

### CROSS-REFERENCE TO RELATED APPLICATIONS

This non-provisional utility application claims priority to UK patent application number 2309364.4 entitled CLUSTERED SERVERS FOR TELECOMMUNICATIONS filed on 21 Jun. 2023, which is incorporated herein in its entirety by reference.

### BACKGROUND

Telecommunications networks are widely used, and comprise nodes connected via network links over which messages may be sent. Subscribers of a telecommunications network correspond to users of the telecommunications network, and are typically identified within the network by an assigned Directory Number, DN or other identifier. When a call is initialized within a telecommunications network, for example, a caller may input a number to a device, which is matched by the telecommunications network to a subscriber using a DN in order to facilitate the routing and/or processing of the call.

Telecommunications networks have traditionally used circuit switching technologies and more recently there is migration from circuit switch to packet switch voice technologies. Where packet switched voice technologies are used it is possible to use cloud resources, including clustered servers, to deploy various components of a telecommunications network.

The examples described below are not limited to implementations which solve any or all of the disadvantages of known apparatus and methods for rehoming configuration data.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a method and corresponding apparatus that provides a way of rehoming configuration data from a failed Application Server, AS, node efficiently, providing a way of quickly recovering from AS node failure and that maintains the ability of a telecommunications network to successfully process calls and communication requests during the rehoming of configuration data from the failed AS node. The technology disclosed herein further ensures a reliable clustered AS system such that communication requests are reliably able to be processed promptly, and further allows deployment of clustered AS systems in environments wherein the availability of AS nodes cannot be highly relied upon. The technology is also used in connection with provisioning flows in some cases, where there are requests to read or change configuration.

In various examples there is a method performed by a location server of a telecommunications network comprising a clustered AS. The method comprises receiving a query for a subscriber, and in response to determining that configuration data associated with the subscriber is on a failed AS node of the clustered AS, determining a healthy AS node of the clustered AS. The method further comprises requesting the healthy AS node to instantiate a configuration block containing configuration data associated with the subscriber and, in response to the configuration block containing configuration data associated with the subscriber being a child configuration block, a first parent configuration block upon which the child configuration block is dependent. Additionally, the method comprises receiving a response from the AS that an identifier, associated with the subscriber has been registered on the healthy AS node, responding to the query with the location of the healthy AS node, and after receiving the response from the AS, adding at least one configuration block on the failed AS node, excluding any configuration block that was requested to be instantiated, to a queue for requesting the healthy AS node to instantiate each configuration block of the queue.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a telecommunications network comprising a location server for rehoming configuration files from a failed AS node;

FIG. 2 is a signaling diagram comprising an example method performed by the location server of FIG. 1;

FIG. 3 is a signaling diagram comprising an example method performed by the location server of FIG. 1, wherein there is an additional location server comprised in the telecommunications network of FIG. 1; and

FIG. 4 illustrates an exemplary computing-based device in which examples of a configuration rehomer for efficiently rehoming configuration data from a failed AS node are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

Using packet switch voice technologies brings many benefits including scalability through use of cloud resources. Another benefit concerns recovery from failures since cloud resources may be used which are distributed and where one node fails there is typically an option to use another, healthy cloud node. The present technology is concerned with use of clustered servers when deploying telecommunications networks so as to achieve benefits such as scalability and/or failure recovery. The inventors have recognized significant problems with use of clustered servers when deploying telecommunications networks in situations where there is dependent subscriber configuration as explained in more detail below.

The technology described herein concerns telecommunications networks comprising a location server and a clustered Application Server, AS. Telecommunications networks are widely known, and facilitate communication between devices of a network, such as teleconferencing, video calling, audio calling, telephony, or other forms of communication. Typically, when a device of a telecommunications network initiates a communication request, such as by initiating a call, the device triggers a request message to the telecommunications network which is received by a routing proxy device. This message typically comprises an identifier usable to identify the requester, and an identifier usable to identify a target of the communication request, such as a second device to which a call from the requesting device is directed. A subject of a communication request is defined herein to refer to an identifiable party of a communication request, such as one or more of: a requester; a target; a third party. Alternatively, the message may be sent when the second device is added to an existing call, or when any other communication to the second device is requested, wherein the message identifies the subject, such as the target device and the sending device, of the communication request.

A clustered Application Server, AS, may be comprised in such a telecommunications network, and is a clustered server comprising nodes, wherein, as described herein, individual ones of the nodes store configuration data to process a call or other communication request associated with a query for a subscriber of the telecommunications network. In various examples, the Application Server described herein is a Call Agent, CA. A location server may also be comprised in such a telecommunications network, and is a server that, upon receiving a query for a subscriber of the telecommunications network, in various examples looks up a subscriber identifier, such as a directory number DN or a session initiation protocol identifier SIP ID, and determines the location of configuration data associated with the subscriber, which is required to process the call or other communication request associated with the query for the subscriber. Used together, AS nodes may register subscriber identifiers with a location server, and a location server may locate a AS node upon which configuration data required to process a call or other communication request associated with a query for a subscriber is located, when such a call or other communication request is received via the telecommunications network.

In a clustered AS, it is sometimes the case that a AS node fails, such as due to hardware or network issues, loss of power, incorrect software or firmware update or other malfunction. The configuration data stored on the failed AS node is rehomed in the case of failure to an active or healthy AS node, in order to facilitate the continued processing of calls or other communication requests via the telecommunications network. Rehoming configuration data is network resource intensive, and results in significant outage and failure of calls or queries for subscribers, in various examples associated with communication requests, whilst rehoming is undergoing.

Within the telecommunications networks described herein, there is situated a clustered AS and a location server. A clustered AS is a AS comprising distributed nodes, where the purpose of the AS is to store configuration data required to enable the processing of communications via the telecommunications network in which the AS is situated. Configuration data comprises parameters, definitions and references that facilitate the execution of a communication. Every subscriber in a telecommunications network has associated configuration data. In various examples, configuration data includes one or more of: communication routing information; subscriber device information; a MAC address of a subscriber device; communication permissions for a subscriber; protocol information; a phone number; a subscriber identifier; a Business Group identifier, whether or not a subscriber has particular call features enabled such as call forwarding, voicemail or other features; private branch exchange (PBX) configuration data comprising parameters of a PBX; configuration data of a subscriber defining the subscriber as belonging to a Multi-Line Hunt Group, MLHG; configuration data of a subscriber defining the subscriber as the pilot of a MLHG; an SIP registration state of a subscriber; information specific to a customer or organization associated with a subscriber; information specific to a customer or organization associated with a business group.

A Business Group, BG, is a group defined within a telecommunications network comprising at least one subscriber. In various examples, a BG corresponds to an organization or enterprise, wherein each subscriber device in various examples corresponds to a device of an end user of the organization or a device belonging to the organization. In various examples, each subscriber of a BG has at least one aspect of their associated configuration data that is unified across the BG. In various examples, each subscriber of a BG has at least one aspect of their associated configuration data that is the same as an aspect of the configuration data associated with another subscriber of the BG. In various examples, configuration data associated with a BG comprises configuration data for an entire enterprise.

As described herein, configuration data is, in various examples, comprised of configuration blocks, which are sub-sections of configuration data. In various examples, at least one configuration block is comprised in a group of configuration blocks, wherein the group is movable in location, such as between AS nodes, within a telecommunications network. In various examples, configuration blocks of a movable group are unable to be moved independently of the group, for the functioning of the configuration data associated with the group of configuration blocks to work as designed. In other words, the entire group must be moved together in order that the configuration data of the group is usable to process communication requests in a telecommunication network, in various examples. In various examples, a configuration block without dependencies i.e. that is not comprised in a tree structure, is a movable configuration block. In various examples, if a movable group is distributed over multiple AS nodes, only configuration data of a single AS node is functional to be used to process communication requests in a telecommunications network. In various examples, the configuration data that is functional is that which comprises a parent configuration block. In various examples, the configuration data that is functional is that which comprises the root of a parent-child structure comprising a child configuration block of the group of configuration blocks. In various examples, configuration data for a BG comprises at least one configuration block corresponding to a subscriber of the BG.

Additionally, configuration blocks of configuration data are, in various examples, interdependent upon one another such that at least one configuration block is dependent upon at least one other configuration block of the configuration data. As such, configuration data in various examples comprises a parent-child i.e. ‘tree’ structure of parent configuration blocks and child configuration blocks, wherein a child configuration block is dependent upon a parent configuration block. A root of the parent-child configuration block structure refers to the highest level of parent configuration block such that the highest level parent configuration block does not have a parent configuration block upon which it is dependent.

In various examples, configuration data, such as for a BG, comprises a parent configuration block relating to at least one aspect of configuration data that is unified across multiple child configuration blocks, and at least one child configuration block associated with subscriber data, the child configuration block relating to the remaining aspects of configuration data beyond those unified aspects. This improves the efficiency of configuration data storage, by reducing the need to duplicate aspects of configuration data that are common across child configuration blocks. However, this configuration block structure introduces dependencies to configuration blocks, wherein a child configuration block, in various examples, is dependent upon a parent configuration block, and both the parent and the child configuration blocks are needed in order to enable processing of a communications request relating to a subscriber associated with the child configuration block. In various examples, the parent and at least one child configuration block are comprised in a group of configuration blocks that are movable between AS nodes. In various examples the entire configuration data for a BG is comprised of a parent configuration block containing BG configuration data relating to unified aspects of configuration data across subscribers of the BG, and at least one child configuration block associated with a subscriber of the BG. In various examples, a configuration block associated with a subscriber contains only configuration data for a single subscriber. In various examples, a configuration block contains configuration data for at least one subscriber and, additionally or alternatively, configuration data for a BG. In various examples, configuration data for a BG is a movable group of configuration blocks, as defined above.

Configuration data is stored on AS nodes of the AS. In various examples, configuration data stored on AS nodes of the AS of a telecommunications network comprises configuration blocks. In various examples, configuration data stored on a AS node relates to a single BG. In various examples, the configuration data relating to a single BG and stored on a AS node comprises parent and child configuration blocks that are interdependent. In various examples, configuration blocks of a tree structure are located on the same AS node. In various examples, the tree structure corresponds to the structure of configuration blocks of a BG, as described above.

As mentioned above, within the telecommunications networks described herein, there is situated a location server. A location server is a server that, upon receiving a query for a subscriber of the telecommunications network, such as a request message as described above, locates configuration data associated with the subscriber of the query including, if any exist, at least one configuration block upon which a configuration block relating to the subscriber of the query is dependent. In various examples, the location server locates configuration data associated with the subscriber of the query including, if any exist, all configuration blocks upon which a configuration block relating to the subscriber of the query is dependent. The location server then responds to the query for a subscriber of the telecommunications network with the location of the configuration data associated with the subscriber. In various examples, the location of the configuration data associated with the subscriber is an identifier unique to a AS node such as an internet protocol IP address. In various examples, the location server responds to a device from which the query for the subscriber originated. In various examples, a first location server that receives the query for a subscriber sends a request to a second location server to perform at least a portion of the functionality of the first location server described herein, and the second location server responds to the first location server by duplicating a response from an AS node, where the first location server then responds to the device that originated the query by sending the location of the configuration data associated with the subscriber. In various examples, the second location server sends the location of the configuration data associated with the subscriber to another entity, in various examples the first location server, which subsequently sends the location of the configuration data associated with the subscriber to the device that originated the query. It should be appreciated that the exact networking setup of, and the devices present within, the telecommunications network affects the routing of the queries and responses described herein outside of those explicitly defined.

In telecommunications networks comprising a clustered AS and a location server, there are numerous problems that may arise. If one of the AS nodes upon which configuration data is stored fails, such as due to networking issues or hardware issues, the configuration data in various examples becomes unusable by at least one device of the telecommunications network. This results in the inability of the telecommunications network to facilitate communication for the subscribers associated with the configuration data of the failed AS node. If the affected subscribers are emergency services related or have other requirements regarding time-sensitive or high priority communication, the inability of the telecommunications network to facilitate communication has serious impacts. There are also stringent requirements that subscribers can themselves communicate with emergency services, with legislative requirements such as in the United States of America requiring that the average downtime for subscribers is less than five minutes per year. Failure of a single AS node, if configuration data associated with an emergency services subscriber is located only on the single AS node, has a significant impact on this downtime. Even if the affected subscribers do not have such stringent communication requirements, a reduction in service of the telecommunications network significantly degrades the ability of users to communicate and degrades the experience for users of the telecommunications network.

In order to ensure that the telecommunications network is able to continue to facilitate communication for subscribers (or to continue to enable a provisioning system to read or change configuration), alternative approaches, when a failed node is detected, rehome all configuration data associated with the failed node to a healthy node, at once. This significantly degrades network performance during the rehoming, especially for failed nodes on which a large amount of configuration data is stored, for example when a large BG is situated on the failed node. Additionally, rehoming all of the configuration data of the failed node takes time, during which communication such as calls to, and additionally or alternatively from, subscribers associated with configuration data located on the failed node is impossible. In various examples, an urgent call to or from a subscriber outside of a large BG, wherein configuration data associated with the large BG and the subscriber is located on a failed node, the urgent call made during the rehoming of the large BG, fails until the configuration data associated with the entire large BG and the configuration data associated with the subscriber are rehomed.

An alternative approach to storing configuration data is a stateless micro-service approach, wherein a database is consistent across AS nodes of a telecommunications network, and a call handler queries the database each time it receives a request for a subscriber in order to obtain configuration data associated with the subscriber, such that when a AS node fails, the call handler is able to query any other AS node. This approach significantly increases traffic and the latency of the telecommunications network, as well as increasing the complexity of the network with respect to opening the possibility of bugs relating to the consistency of the database across AS nodes.

The present technology provides an efficient way of ensuring that a telecommunications network is able to continue to facilitate communication (and/or to facilitate operation of a provisioning system) for subscribers when a AS node fails, and is able to quickly recover a communication request from AS node failure, by efficiently triggering the rehoming of configuration data associated with a subscriber that is the subject of a request received by a location server. A request received by a location server, in various examples, reflects an active communication request, such as a call. When the subject of the communication request has configuration data located on a failed node, such that the active communication request is not able to be processed, the present technology prioritizes the rehoming to a healthy AS node of a configuration block associated with the subject of the communication request and, if applicable, a first parent configuration block upon which the configuration block associated with the subject is dependent. This ensures that the active communication request is responded to in as short a time as possible (which may be referred to as a fast lane) with the location of a minimal amount of configuration data that is required for a communication session to take place. If the configuration block associated with the subscriber is a child configuration block and is comprised in a movable group of configuration blocks as defined above, wherein the movable group of configuration blocks comprises at least one additional configuration block to the child configuration block and a parent configuration block, only the configuration data of the movable group that is actively required is rehomed immediately. After the rehoming of the configuration data associated with the subscriber of the received request, the present technology queues remaining configuration blocks on the failed AS node, in various examples queuing dependencies (which may be referred to as a slow lane) associated with the parent configuration block (and therefore the child configuration block) that were rehomed initially excluding those configuration blocks that have already been rehomed, for future rehoming, thereby enabling that remaining and in various examples dependent configuration data is eventually rehomed and will be available as required for future communication requests. In some cases the location server rehomes all ancestors associated with an active communication request; for example where an active communication request requires a configuration block the location server will rehome all ancestors of the required configuration block in some cases. In cases where a provisioning system is present in a communications network, the provisioning system is able to read and/or change configuration in an ongoing manner despite failed nodes of an application server. In some examples the same location server is used to both enable communications flows to continue and to enable provisioning system reads and changes to configuration to continue despite failure of a node in a clustered application server.

The queuing system of the present technology further enables the prioritization of configuration data rehoming, such that the most relevant configuration data is being rehomed at any given point, and enables a reduction in latency of the telecommunications network by allowing rehoming from the queue depending on parameters such as current network latency, number of active calls, or historical data regarding subscriber activity. In various examples, the present technology is used to enable rehoming only whilst network latency of the telecommunications network is below a threshold value, thereby maintaining an acceptable degree of network latency, wherein the maintained latency is smaller than the latency when attempting to rehome all data at once.

The queuing system of the present technology further enables the dynamic re-prioritization of configuration data rehoming (which may be referred to as switching lanes). In various examples, a new active communication request such as a call is received via the telecommunications network which references a subscriber that is in the rehoming queue. In various examples, in response to receiving a request for the subscriber, the location server prioritizes the rehoming of the configuration block associated with the subscriber of the active communication request and a parent configuration block, enabling successful connection in a far shorter time than if the configuration data ahead of the configuration data associated with the subscriber in the queue had to be rehomed first. As such, the present technology enables a smooth experience for subscribers with fewer failed communication requests such as calls, compared to if the queuing system of the present technology was not implemented.

Rehoming configuration data is defined herein as the instantiation, by a AS node, of configuration data. In various examples, the AS node instantiates the configuration data by loading the configuration data from a backup database. In various examples, in response to a failed AS node becoming healthy after instantiation of a configuration block on the failed AS node on a healthy AS node, the location server determines which block on the now-healthy failed AS node or the healthy AS node is a correct block, wherein a correct block is a block which is used to process communication requests of the telecommunications network. In various examples, the block on the now-healthy failed AS node and the healthy AS node that is not determined to be the correct block is uninstantiated, in various examples by the now-healthy failed AS node. In various examples, in response to the now-healthy failed AS node having on it more configuration blocks of a movable group of configuration blocks than the healthy AS node, the configuration blocks of the movable group of configuration block on the now-healthy failed AS node are determined to be correct blocks. In various examples, the corresponding blocks of the healthy AS node are uninstantiated. In various examples, all blocks on the now-healthy failed AS node that have corresponding blocks on the healthy AS node are determined to be correct blocks. In various examples, all blocks of the healthy AS node are uninstantiated. In various examples, the backup database is distributed such that there is a copy of the database on every AS node. In various examples, the backup database is distributed such that there is a copy for every 1, 2, 5, 10, 20, 50 or other number of AS nodes. In various examples, the backup database is distributed such that there is a copy for every geographically positioned site of the telecommunications network, where a geographically positioned site is a physical site comprising hardware upon which at least one AS node is located, and wherein at least one geographically positioned site is associated with the telecommunications network. In various examples, the backup database contains a copy of the configuration data on a particular AS node in text format or in binary form, identified with a configuration block identifier that is registered with the location server and a subscriber identifier or BG identifier corresponding to the subscriber or BG respectively, with which the configuration block is associated. Storing the copy in binary form brings efficiencies.

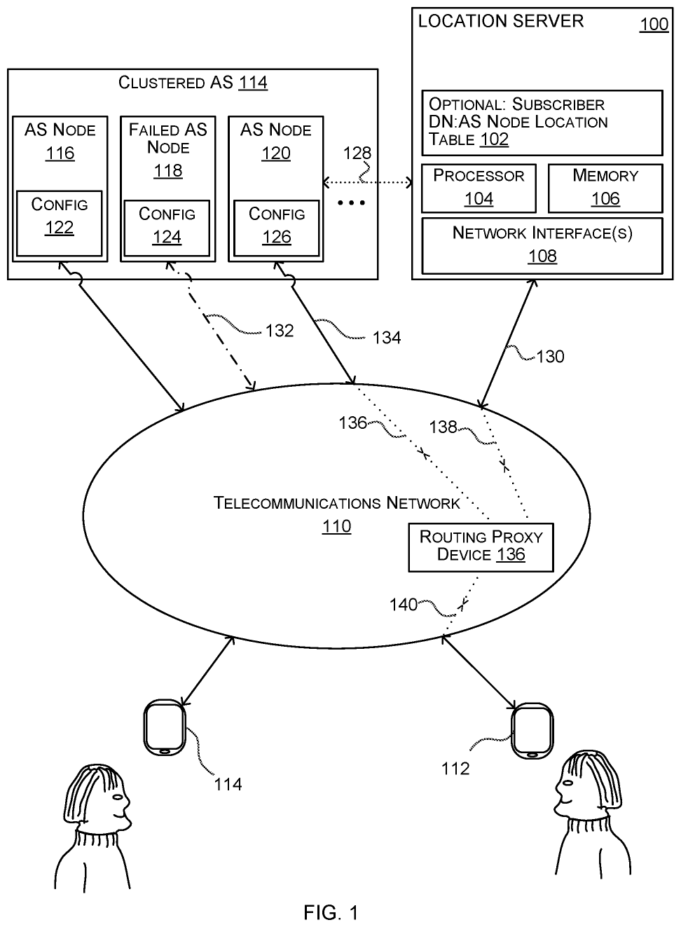

FIG. 1 is a schematic diagram of a telecommunications network 110 comprising a location server 100 for rehoming configuration files from a failed AS node. Telecommunications network 110 further comprises a clustered AS 114 comprising AS nodes 116, 118 and 120. In various examples, clustered AS 114 comprises 1, 2, 3, 5, 10, 15, 20 or more AS nodes. As referred to in FIG. 1, ‘config’ corresponds to ‘configuration data’.

The central telecommunications network 110 is illustrative of devices and connection routes beyond those explicitly shown, as it should be appreciated that any number of networking configurations and additional networked devices beyond those explicitly shown are possible and could feasibly be implemented.

The AS nodes of the clustered AS 114 in various examples, are distributed geographically, such that they are implemented using hardware situated in different physical locations to each other. In various examples, the AS nodes of the clustered AS 114 are distributed into at least one group, such that each group of AS nodes is implemented using hardware situated in different physical locations to each other. This ensures geographical redundancy, and reduces the risk of all AS nodes failing should a geographically-specific event such as a power cut, earthquake, or other natural disaster occur.

Failed AS node 118 corresponds to a AS node that is in some way ineffective as compared to its usual or specified operation. In various examples, a failed AS node is at least one of: unable to connect to the telecommunications network 110; implemented on hardware which is defective; unable to be connected to by a device of the telecommunications network 110. In contrast, as healthy AS node is defined herein as a AS node that is at least one of: operating normally; able to be connected to by a device of the telecommunications network 110; implemented on hardware which is not defective; able to connect to the telecommunications network 110.

Subscriber devices 112 and 114 are also associated with the telecommunications network 110, and are operated respectively by different users. In various examples, subscriber devices 112 and 114 are alternatively operated by a same user.

Location server 100 is further associated with the telecommunications network 110, and is connected to the network via connection 130. Location server 100 comprises a processor 104, memory 106, and at least one network interface 108. In some examples the location server 100 is a SIP location server. AS nodes 116, 118 and 120 each have situated upon them configuration data 122, configuration data 124 and configuration data 126 respectively. In various examples, configuration data 122, 124 and 126 are each comprised of configuration blocks. In various examples, the configuration blocks of configuration data 122, 124 and 126 are comprised in a tree structure such that at least one configuration block of each configuration data is dependent upon at least one other configuration block of the configuration data, and such that parent and child configuration blocks are definable.

In various examples, a user associated with subscriber device 112 attempts to make a call to a user associated with subscriber device 114. In various examples, the user associated with subscriber device 112 attempts to make a different kind of communication request such as a video call, text message, or voice message to a user associated with subscriber device 114. In making the communication request, subscriber device 112 sends a request to the telecommunications network.

In various examples, the telecommunications network 110 comprises a routing proxy device 136, as defined herein. In various examples, an alternate device or multiple devices to the routing proxy device 136 but that function in the same way are implemented. It should be noted that, whilst the routing proxy device 136 is depicted in FIG. 1 alongside simple communication paths connected to the routing proxy device 136, this specific setup is in various examples replaced with or accompanied by one or more alternative communication paths and/or devices. The paths in FIG. 1 are merely exemplary. In various examples, the routing proxy device 136 routes received requests, in various examples a Session Initiation Protocol, SIP request associated with a communication request of the telecommunications network 110, to an AS node which it deems appropriate, wherein appropriate, in various examples, corresponds to an AS node having configuration data located on it used to process the communication request. Path 140 corresponds to the receiving of a communication request from subscriber device 112, wherein the routing proxy device 136 communicates with the location server via path 138 and 130 to obtain a location of an AS node, such as AS Node 120 having configuration data, such as configuration data 126, required to process the communication request, such as configuration data associated with subscriber device 112. The routing proxy device 136 then uses this location information to route the communication request to AS Node 120 via path 136 and 134 to enable the processing of the communication request. In various examples, the routing proxy device further communicates with subscriber device 114 via an additional path. In various examples, the communication request is received by the routing proxy device 136, which interprets the communication request to identify at least one subject of the communication request. In the example of a call initiated by subscriber device 112 towards subscriber device 114, the routing proxy device 136 identifies subscriber device 112 and subscriber device 114 as subjects of the request. In various examples, the routing proxy device 136 is a Representative Application Server, RPAS (trademark).

In various examples, the routing proxy device then sends a query to the location server 100, such as via connection 130 which in various examples interfaces via an interface of the at least one network interface 108, for one of the subject subscribers of the communications request. In various examples, the routing proxy device subsequently sends a query to the location server 100 for each subject subscriber of the communications request. In various examples, the routing proxy device sends a query for all subject subscribers of the communications device to location server 100. In various examples, the routing proxy device sends a query for subscriber device 112 to location server 100. In various examples, the routing proxy device sends a query for subscriber device 114 to location server 100. It should be understood that subscriber and subscriber device are interchangeable, as devices 112 and 114 are users of the telecommunications network 100.

The location server 100 receives, via an interface of the at least one network interface 108, a query for a subscriber. In various examples, the location server 100 receives, via an interface of the at least one network interface 108, a query for subscriber 112. In various examples, the location server 100 receives, via an interface of the at least one network interface 108, a query for subscriber 114. In various examples, the location server 100 receives, via an interface of the at least one network interface 108, a query for at least one subject of a communications request, such as subscribers 114 and 112.

In response to determining that configuration data associated with the subscriber, in various examples subscriber 112 such that the configuration data is comprised in configuration data 124, is located on a failed AS node 118, the location server 100 determines a healthy AS node of the clustered AS 114.

The location server, in various examples, stores a table 102 of subscriber identifier and corresponding AS node upon which configuration data for the subscriber is located. In various examples, when a AS node first initializes configuration data for a subscriber, the AS node registers the subscriber's identifier and the location of the AS node with the location server 100, so as to start a record. In various examples, whenever a AS node initializes configuration data for a subscriber, the AS node registers the subscriber's identifier and the location of the AS node with the location server 100, which updates the table 102 of subscriber identifier and corresponding AS node. In various examples, the identifier of a subscriber is manually or automatically defined when a subscriber is added to the telecommunications network 110. In various examples, registering a subscriber's identifier and a AS node location with the location server 100 corresponds to sending a message comprising the subscriber's identifier and a AS node location to the location server 100, wherein the location server 100 updates the subscriber identifier: AS node location table 102. In various examples, the AS node location is an identification number that is unique to the AS node.

In various examples, the location server 100 determines that configuration data associated with the subscriber is located on a failed AS node by attempting to connect to or send a message to a AS node associated with an identifier of the subscriber in the table 102. In various examples, the AS node that is attempted to be connected to or attempted to be communicated with returns an error message, which indicates to the location server 100 that the AS node containing the configuration data associated with the subscriber is a failed AS node. In various examples, the AS node that is attempted to be connected to or attempted to be communicated with is unable to be communicated with or connected to, thereby indicating a failed AS node. In various examples, the AS node that is attempted to be connected to or attempted to be communicated with is unable to be communicated with or connected to, and the location server 100 reattempts communication a predetermined number of times, before concluding, if communication has not been successful, that the AS node is a failed AS node. In various examples, the location server 100 maintains a Stream Control Transmission Protocol, SCTP or Transmission Control Protocol, TCP connection to each AS, and constantly monitors the status of each AS via a heartbeat. In these examples, when the location server 100 receives a query, it already knows whether the associated AS is healthy, based on its TCP or SCTP connection. Similarly, this connection is, in various examples, used to determine a healthy AS node, by monitoring the heartbeat. In various examples, a heartbeat corresponds to a regular sequence of at least one packet. In various examples, if at least one packet of the heartbeat of an AS node is not received by the location server 100, it is determined that the AS node has failed.

Conversely, the location server 100, in various examples, determines a healthy AS node by randomly iterating through possible AS nodes and attempting communication or connection until communication or connection is successful, at which point it is determined that the AS node is healthy. In various examples, the location server 100 chooses a AS node based on the table 102 to which to attempt communication or connection. In various examples, the location server 100 iterates through possible AS nodes until communication or connection is successful, and additionally, until no error messages are received from the AS node, at which point the location server 100 assumes the AS node to be healthy.

In various examples, the location server 100 connects or attempts connection to a AS node directly, such as via path 128. In various examples, the location server 100 connects or attempts connection to a AS node through the telecommunications network 110, such as via the path 130 and 132 or 130 and 134. Such a connection, in various examples, is via a specific protocol, via additional devices, or using an alternate routing mechanism, compared to a direct connection such as via 128. The specific nature of the connection path is not elaborated on here, given that the connection path is strongly dependent upon the telecommunications network architecture chosen. In various examples, the location server 100 communicates with at least one AS node via a first interface of the network interfaces 108 using TCP as a network layer protocol and an additional application layer protocol, in order to request instantiation of configuration blocks and, in various examples, receive a heartbeat from at least one AS node. In various examples, the location server 100 receives a query from a routing proxy device using the same additional application layer protocol, but where the information related to the query is received on a different port of the location server 100 using a second interface of the network interfaces 108. In various examples, during an instantiation on an AS node, at least one AS node sends a query to the location server for additional configuration information, in various examples via the second interface.

Once the location server 100 has determined a healthy AS node of the clustered AS 114, it requests, such as via an interface of the at least one network interface 108, the healthy AS node to instantiate a configuration block containing configuration data, in various examples the configuration data located on the failed AS node, associated with the subscriber. In various examples, the configuration data associated with the subscriber is contained in a child configuration block which is dependent upon a parent configuration block. In various examples, the configuration data associated with the subscriber is configuration data associated only with the subscriber.

Requesting the healthy AS node to instantiate a configuration block associated with the subscriber efficiently ensures that the configuration data for the communication request to be successfully processed is rehomed and able to be used by the telecommunications network. In response to the configuration block associated with the subscriber being a child configuration block, such as in response to the configuration data associated with the subscriber on the failed node being comprised in a tree structure with parent and child configuration blocks, such as configuration data associated with a BG comprising the subscriber, the location server 100 further requests the healthy AS node to instantiate a first parent configuration block of the child configuration block. This efficiently ensures that minimal configuration data required for the communication request to be successfully processed is rehomed even in the case of dependencies, and is able to be used by the telecommunications network.

Once the healthy AS node has instantiated the requested configuration blocks, the AS 114 sends a response to the location server 100, such as via an interface of the at least one network interface 108, that a subscriber identifier associated with the subscriber has been registered on the healthy AS node. In various examples, the healthy AS node sends a response, such as via an interface of the at least one network interface 108, to the location server 100 that a subscriber identifier associated with the subscriber has been registered on the healthy AS node. In various examples, the location server 100 therefore updates the table 102 with the new AS node location of the subscriber configuration data. In various examples, the healthy AS node uses connection path 128 to communicate the response that a subscriber identifier has been registered to the location server 100.

In response to receiving the response from the AS that a identifier associated with the subscriber has been registered on the healthy AS node, the location server 100 responds, such as via an interface of the at least one network interface 108, to the query that was originally received with the location of the healthy AS node. This ensures that the communication request such as a call from which the query for a subscriber originated is able to be processed quickly and enables the immediate processing of the communication request without a requirement to wait for any additional configuration data to be rehomed.

Additionally, after receiving the response from the AS that an identifier associated with the subscriber has been registered on the healthy AS node, and in various examples after responding to the query that was originally received with the location of the healthy AS node, the location server 100 adds at least one configuration block on the failed AS node, in various examples all configuration blocks on the failed AS node, excluding any configuration block that was requested to be instantiated, to a queue for requesting the healthy AS node to instantiate each configuration block of the queue. In various examples, configuration data located on the failed AS node comprises a plurality of configuration blocks, wherein the plurality of configuration blocks comprises at least an additional configuration block to the configuration blocks requested to be instantiated by the location server 100. This enables that additional configuration data located on the failed AS node beyond the data associated with the subscriber and a parent configuration block if such a parent configuration block was instantiated, is eventually requested to be instantiated on a healthy AS node, thereby maintaining the ability of the telecommunications network to facilitate communication even with a failed AS node. If a new communication request is received which requires the additional configuration data in order for the request to be processed, having that additional configuration data already on a healthy AS node enables the immediate processing of the request and does not impact the telecommunication network such as through an increase in latency as would be a consequence of needing to rehome the additional configuration data upon receiving the request.

In various examples, the at least one configuration block on the failed AS node added to the queue is any one or more of: in response to a parent-child structure comprising the first parent configuration block, the parent-child structure comprising an additional parent configuration block, at least one additional parent configuration block including the root of the parent-child structure; at least one child configuration block associated with any one or more of: the first parent configuration block, the at least one additional parent configuration block.

Queuing additional parent configuration blocks and, in various examples, child configuration blocks associated with parent configuration blocks of the parent-child structure ensures that interdependent configuration data directly and indirectly associated with the configuration block associated with the subscriber is eventually loaded, thereby maintaining the ability of the telecommunications network to facilitate communication even with a failed AS node. This is especially advantageous if the subscriber of the query received by the location server 100 is comprised in a BG with associated configuration data which comprises a tree structure with child and parent configuration blocks, as, whilst a communication request is able to be processed using only a child subscriber configuration block and a parent configuration block, this in various examples results in degraded performance until the entire dependency tree is rehomed, at which point regular operation is achieved. Queuing only dependencies of the configuration block associated with the subscriber enables the rehoming of only data relating to the received query of the location server 100, which is efficient especially if the failed AS node eventually returns to a healthy state, as additional configuration data that is not a dependency for the configuration block associated with the subscriber does not need to be rehomed. In various examples, the configuration blocks chosen to be queued are chosen based on a determined priority, wherein the priority of a configuration block is elaborated upon below.

It should be appreciated that the at least one network interface 108 in various examples is a group of network interfaces such that communication via multiple protocols is enabled. In various examples, the location server 100 communicates with AS nodes via Stream Control Transmission Protocol, SCTP using an interface of the at least one network interface 108 that supports SCTP. In various examples, rather than communication directly with AS nodes, the location server 100 communications with the AS 114 via SCTP, and communication is one or more of: routed to; translated for; received by AS nodes.

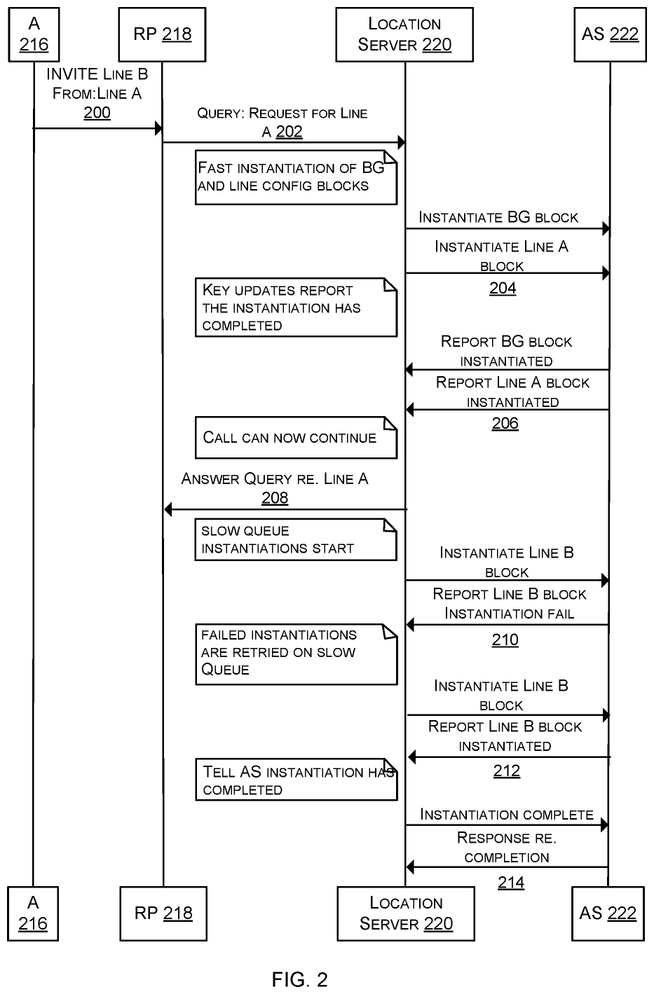

FIG. 2 is a signaling diagram comprising an example method performed by the location server of FIG. 1. Devices 216, 218, 220 and 222 are comprised in the same telecommunications network. Mention of ‘re.’ in this diagram is shorthand for ‘regarding’. RP 218 represents a routing proxy device as defined herein. A signaling diagram comprises a depiction of entity horizontally across the diagram, wherein a single entity is represented by a single line, and a depiction of time vertically, wherein time increases towards the bottom of the chart. In various examples, the signaling diagram shows the time order of the method blocks and actions described herein. In various examples, the method blocks and actions described herein are performed in a different time order to that depicted in the signaling diagram. Line A 216 corresponds to a subscriber of the telecommunications network, reflecting, for example, subscriber device 112 or subscriber device 114. Line A 216 sends a signal 200 to a routing proxy device 218 of a telecommunications network inviting Line B to a communication session. This signal corresponds to the example of a communication request such as a call from subscriber device 112 directed towards subscriber device 114 discussed above, wherein, in the context of FIG. 2, Line A 216 corresponds to subscriber device 112 and Line B corresponds to subscriber device 114. In various examples, the routing proxy device 218 is alternatively a networked device that is not an routing proxy device, but which performs a similar function of requesting the location of configuration data required to process a received communication request.

Upon receiving the signal 200 comprising subject subscribers Line A and Line B, the routing proxy device 218 queries 202 the location server 220 for Line A. In various examples, the routing proxy device 218 queries the location server 220 for Line B and in various examples, Line A.

The location server 220 receives the query 202 for subscriber Line A, and, in response to determining that configuration data associated with the subscriber Line A is on a failed AS node of a clustered AS 222, determines a healthy AS node of the clustered AS 222. The location server 220 sends a request 204 to the healthy AS node to instantiate a configuration block, in various examples a single configuration block, containing configuration data associated with the subscriber, in various examples configuration data associated only with the subscriber, and, in response to the configuration block containing configuration data associated with the subscriber being a child configuration block, a first parent configuration block, in various examples a single first parent configuration block, upon which the child configuration block is dependent. In various examples, the configuration data associated with subscriber Line A is a child configuration block of a parent-child structure, and therefore has dependencies on at least one parent configuration block. In various examples, the parent-child structure comprises at least one additional configuration block beyond those requested to be instantiated. In various examples, the parent-child structure comprises a movable group of configuration blocks such that configuration blocks of the parent-child structure are to be located on the same AS node in order that configuration data of the movable group is functional to be used for the processing of communication requests by a telecommunications network. As such, the location server 220 requests the healthy AS node to instantiate the child configuration block associated with subscriber Line A and a configuration block upon which the Line A block is dependent. The methods and systems described herein, in various examples, receive a query for a subscriber wherein a configuration block associated with the subscriber has a parent configuration block upon which it is dependent. In various examples, the configuration block associated with the subscriber is a configuration block associated with only the subscriber.

In various examples, determining that configuration data associated with the subscriber Line A is on a failed AS node comprises checking that a connection to a AS node of the clustered AS 222 associated with the subscriber is unavailable. In various examples, the AS 222 or at least one node of the AS 222 registers subscriber identifiers with the location server 220 such that the location server 220 stores a table comprising, for each subscriber identifier, an associated location of a AS node of the AS 222 upon which configuration data associated with the subscriber is stored. In various examples, the request 204 is sent from the location server 220 directly to the healthy AS node. In various examples, the request 204 is sent from the location server 220 to another device of the clustered AS 222 and thereby indirectly to the healthy AS node. In various examples, the request 204 is sent from the location server 220 to another device of the clustered AS 222 excluding a failed AS node. In various examples, the device excluding a failed AS node is a supervisor node of the AS upon which configuration data for the processing of communication requests by a telecommunications network is not stored and which appropriately routes received requests to AS nodes.

Once the requested instantiation by the healthy AS node is complete, the healthy AS node sends a response 206 to the location server 220. In various examples, the response 206 is sent from the healthy AS node directly to the location server 220, or is sent from the healthy AS node to another device of the clustered AS 222 and thereby indirectly to the location server 220. The response 206 indicates that a CN associated with the subscriber Line A has been registered on the healthy AS node i.e. that instantiation of the configuration data associated with Line A has been successfully completed. In various examples, the location server 220 uses this response to update a stored table comprising subscriber identifier and associated AS node location upon which the configuration data associated with the subscriber is stored. In various examples, the AS node location is a unique identifier of the AS node.

Upon receiving the response 206 from the AS 222, the location server 220 responds 208 to the original query 202 with the location of the healthy AS node, thereby enabling the processing of the communication request 200 quickly.

After receiving the response 206 from the AS 222, and in various examples after responding 208 to the original query 202, the location server 220 further adds at least one configuration block on the failed AS node, in various examples all configuration blocks on the failed AS node, excluding any configuration block that was requested to be instantiated, to a queue for requesting the healthy AS node to instantiate each configuration block of the queue.

In various examples, the at least one configuration block on the failed AS node added to the queue is any one or more of: in response to a parent-child structure comprising the first parent configuration block, the parent-child structure comprising an additional parent configuration block, at least one additional parent configuration block including the root of the parent-child structure; at least one child configuration block associated with any one or more of: the first parent configuration block, the at least one additional parent configuration block.

In various examples, the configuration data associated with subscriber Line A is a child configuration block of a parent-child structure, and therefore has dependencies on at least one parent configuration block. As such, after receiving the response 206 from the AS 222, the location server 220 in various examples adds configuration blocks of the parent-child structure excluding those already requested to be instantiated to a queue for further requesting the healthy AS node to instantiate each configuration block of the queue. In various examples, configuration data associated with Line A and Line B belongs to the same parent-child structure, thus after receiving the response 206 from the AS 222, the location server 220 adds a configuration block associated with subscriber Line B to a queue for requesting the healthy AS node to instantiate each configuration block of the queue.

In various examples, configuration data associated with Line A and Line B does not belong to a same parent-child structure but is located on the same AS node. In these examples, the location server 220, after receiving the response 206 from the AS 222, in various examples, adds the configuration block associated with Line B to the queue for requesting the healthy AS node to instantiate each configuration block of the queue.

In various examples, the location server 220 iteratively requests the healthy AS node to instantiate each configuration block of the queue. In various examples, each request is accompanied by a response from the AS 222 providing confirmation of successful instantiation. In various examples, in response to the request being to instantiate configuration data associated with a subscriber, the AS 222 responds that an identifier associated with the subscriber has been registered on the healthy AS node. In various examples, in response to the request being to instantiate configuration data associated with a BG or other entity, the AS 222 responds that an identifier associated with BG or other entity has been ben registered on the healthy AS node. Request-response process 210 is depicted, wherein the first configuration block to be requested in the queue is a configuration block associated with subscriber Line B, therefore the location server 210 requests the healthy AS node to instantiate the configuration block associated with subscriber Line B.

In various examples, the queue is iterated through by the location server 220 randomly, such that any configuration block of the queue has an equal probability to be requested to be instantiated by the healthy AS node during iteration. In various examples, iteration through the queue by requesting the healthy AS node to instantiate queued configuration blocks is allowed to occur only when a property of the telecommunications network is below or above a predetermined threshold metric. In various examples, iteration through the queue is allowed to occur only when a latency of the telecommunications network is below a predetermined threshold value. In various examples, iteration through the queue is allowed to occur only when a number of active calls or other communication requests of the telecommunications network are undergoing. In various examples, iteration through the queue is allowed to occur only during predetermined time periods, wherein the predetermined time periods are, in various examples, determined by considering historical subscriber activity. Time periods during which there is significant subscriber activity, such as more calls or other communication requests compared to alternative time periods, are in various examples used to block the queue from being iterated through.

In various examples, a request of the healthy AS node to instantiate a configuration block that is unsuccessful is reattempted. In various examples, the unsuccessful request is reattempted immediately, regardless of the other configuration blocks of the queue. In various examples, the unsuccessful request is readded to a queue, which is in various examples, the queue from the request was triggered. In various examples, in response to requesting the healthy AS node to instantiate a configuration block failing less than a predetermined number of times, the location server 220 reattempts to request the healthy AS node to instantiate the configuration block, and in response to requesting the healthy AS node to instantiate the configuration block failing more than a predetermined number of times, the location server 220 adds the configuration block to a failure queue, wherein each configuration block of the failure queue is configured to be requested to be instantiated after at least one other queue is clear of blocks. In various examples, each configuration block of the failure queue is configured to be requested to be instantiated after other queues are clear of blocks. In various examples, a failure queue as described herein is implemented additionally or alternatively to a first and a second queue, or any other number of or type of queues.

Request-response process 210, and reattempt request-response process 212, is illustrative of a reattempt process as described above, wherein the response of request-response process 210 indicates that instantiation of the configuration block associated with subscriber Line B failed.

In various examples, after the successful instantiation of a configuration block, such as after a response from the AS 222 that an identifier of an entity associated with the configuration block has been registered on the healthy AS node, the location server 220 responds to the routing proxy device 218 with the location of the configuration block. In various examples, the routing proxy device 218 is any other entity from which a query for a subscriber is received by the location server 220.

In various examples, the location server 220, once all queues are clear for a particular moveable block of configuration, sends a message to the AS 222 that instantiation is complete for that moveable block of configuration, and that AS 222 is not to expect further configuration block instantiation requests for that block associated with the query 202. Request-response process 214 is illustrative of this completion message.

In various examples, the queue of the location server 220 is a first queue, in various examples equivalently referred to as a ‘slow queue’, and the location server 220 moves at least one of: a configuration block of the first queue to a second queue, in various examples equivalently referred to as a ‘fast queue’; a configuration block of the second queue to the first queue, wherein each configuration block of the second queue is configured to be requested to be instantiated by the healthy AS node before any block of the first queue. In various examples, a configuration block of the first queue is moved to the second queue using a determined priority of the configuration block, wherein a higher priority configuration block is moved to the second queue before a lower priority configuration block. In various examples, a configuration block of the second queue is moved to the first queue using a determined priority of the configuration block, wherein a lower priority configuration block is moved to the first queue before a higher priority configuration block. It should be appreciated that any number of queues are capable of being implemented by the location server 220, such that configuration blocks are moved between each queue depending on priority. In various examples, there is a slow, medium and fast queue (first, second and third queues respectively), wherein each block of the third queue is requested to be instantiated by the healthy AS node before any block of the second queue, and each block of the second queue is requested to be instantiated before any block of the first queue. In various examples, a block of the first queue is one or more of: moved to the third queue, moved to the second queue. In various examples, a block of the second queue is one or more of: moved to the first queue; moved to the third queue. In various examples, a block of the third queue is one or more of: moved to the first queue; moved to the second queue. In various examples, the third queue contains configuration blocks of a higher determined priority than configuration blocks of the second queue, and the second queue contains configuration blocks of a higher determined priority than configuration blocks of a first queue. In various examples, the third queue contains configuration blocks that are of a higher determined priority than every configuration block of the second queue, and the second queue contains configuration blocks that are of a higher determined priority than every configuration block of the first queue. In various examples, these concepts, and those relating to queues as described herein, are extended to four, five, six, ten, twenty or any other number of queues.

In various examples, the priority of a configuration block is determined by considering any one or more of: whether a subscriber associated with the configuration block is currently attempting to make a call via the telecommunications network, whether the configuration block is associated with configuration of a business group comprising subscribers, whether the configuration block has any dependencies, whether the configuration block is a dependency for another configuration block, a number of dependents of the configuration block, the priority of any dependents of the configuration block, a type of the configuration block, historical data regarding a subscriber associated with the configuration block, existence of a provisioning request for the block.

In various examples, a predetermined number of configuration blocks are allowed in the second queue at any given time, and the location server 220 moves configuration blocks from the first queue to the second queue based on the highest priority configuration blocks as soon as a space in the second queue opens. In various examples, a block with a higher priority is moved to the second queue before a block with a lower priority. In various examples, the location server 220 moves blocks from the first queue to the second queue at predetermined intervals. In various examples, the location server 220 moves blocks from the first queue to the second queue only when the determined priority of a configuration block of the first queue exceeds a threshold priority.

In various examples, the location server 220 moves a configuration block from the second queue to the first queue, in response to the priority of the configuration block being lower than a priority of a configuration block in the first queue.

In various examples, in response to a subscriber associated with a configuration block, the subscriber currently attempting to make a call or other communication request, or being involved in an active communication request via the telecommunications network, the configuration block is given a higher priority than a configuration block that is not associated with an active call or other communication request. In various examples, the configuration block is given a priority higher than any other configuration block that is not currently attempting to make a call or other communication request. In various examples, priority is one of: low; medium; high. In various examples, priority is a numerical value ranging from 0-10, 0-100, 5-50 or any other range, numerical or non-numerical.

In various examples, the type of a configuration block is one of: line; Private Branch Exchange, PBX; multi-line hunt group. In various examples, the type of a configuration block relates to the type of a subscriber, including an entity within which the subscriber is situated, with which the configuration block is associated.

In various examples, a type of a configuration block is associated with a premium service, and the configuration block is therefore determined to have a higher priority than a type of a configuration block not associated with a premium service.

In various examples, a configuration block which has a dependent is determined to have a higher priority than a configuration block which does not have a dependent. In various examples, a number of dependents of a first configuration block that is higher than a number of dependents of a second configuration block results in the first configuration block being determined to have a higher priority than the second configuration block.

In various examples, a configuration block which has a dependent which has a higher priority than a second configuration block, is determined to have a higher priority than a configuration block upon which the second configuration block is dependent.

In various examples, historical data showing that a subscriber associated with a configuration block is unlikely to attempt a communication request before a subscriber associated with a second configuration block results in the determination of a higher priority of the second configuration block than the priority of the first configuration block.

In a first example reflecting the methods described herein with reference to FIG. 2, an entire configuration data of a BG is stored on a same node of a clustered AS and the entire configuration data of the BG is comprised of configuration blocks, at least one configuration block of the configuration blocks dependent upon another configuration block of the configuration blocks. In various examples, the entire configuration data of the BG is comprised of a parent configuration block and at least one child configuration block, wherein, in various examples, the parent configuration block comprises configuration data of the BG and the at least one child configuration block comprises configuration data of a subscriber, wherein the child configuration block is dependent upon the parent configuration block. In various examples, the configuration data of the BG relates to configuration data that is unified across child configuration blocks, such as subscribers. In various examples, the entire configuration data of the BG is a movable group of configuration blocks, as defined herein. A method in this first example, performed by a location server of a telecommunications network comprising the AS, comprises: receiving a query for a subscriber of the business group corresponding to a subject of a call via the telecommunications network; in response to determining that configuration data associated with the subscriber is on a failed AS node of the clustered AS: determining a healthy AS node of the clustered AS; requesting the healthy AS node to instantiate a parent configuration block and a child configuration block of the entire configuration data of the business group, wherein the parent configuration block contains configuration data of the business group, and wherein the child configuration block is dependent upon the parent configuration block and contains configuration data associated with the subscriber; receiving a response from the AS that an identifier, associated with the subscriber has been registered on the healthy AS node; responding to the query with the location of the healthy AS node; and after receiving the response from the AS, adding at least one configuration block associated with the entire configuration data of the business group excluding the parent and the child configuration block that were requested to be instantiated, to a queue for requesting the healthy AS node to instantiate each configuration block of the queue. In various examples, after receiving the response from the AS, the method of this example comprises adding all configuration blocks associated with the entire configuration data of the business group excluding the parent and the child configuration block that were requested to be instantiated, to a queue for requesting the healthy AS node to instantiate each configuration block of the queue. In various examples, only parent configuration blocks of the instantiated child configuration block are added to the queue.

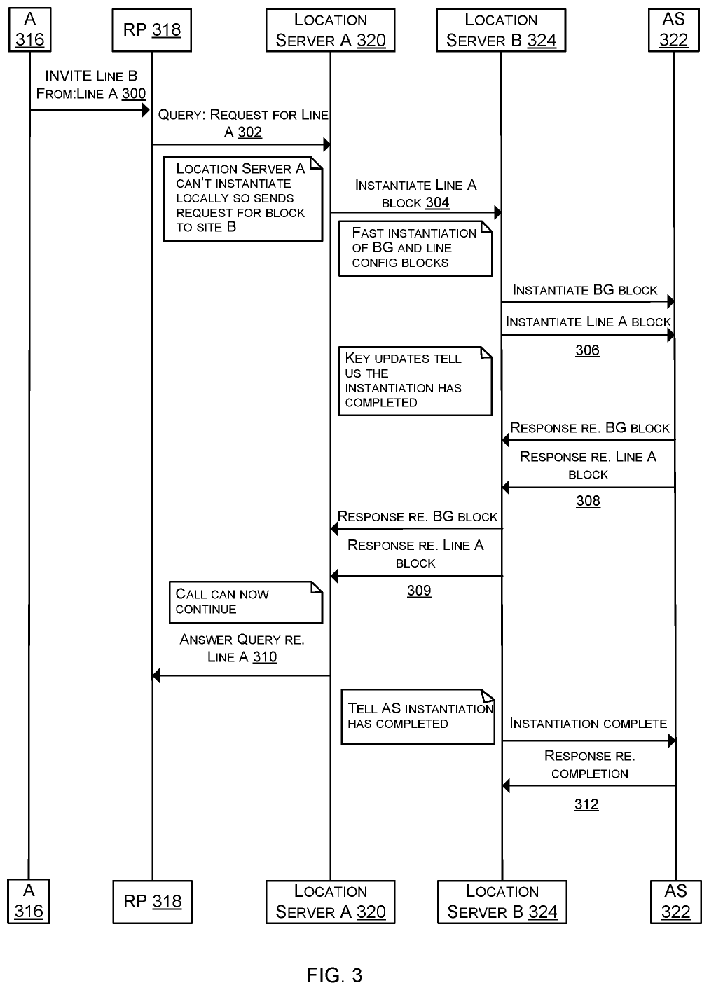

FIG. 3 is a signaling diagram comprising an example method performed by the location server of FIG. 1, wherein there is an additional location server comprised in the telecommunications network of FIG. 1. Mention of ‘re.’ in this diagram is shorthand for ‘regarding’. RP 218 represents a routing proxy device as defined herein. A signaling diagram comprises a depiction of entity horizontally across the diagram, wherein a single entity is represented by a single line, and a depiction of time vertically, wherein time increases towards the bottom of the chart. In various examples, the signaling diagram shows the time order of the method blocks and actions described herein. In various examples, the method blocks and actions described herein are performed in a different time order to that depicted in the signaling diagram.

Similarly to FIG. 2, subscriber Line A 316 sends a signal 300 to a routing proxy device 318 of a telecommunications network inviting Line B to a communication session. This signal corresponds to the example of a communication request such as a call from subscriber device 112 directed towards subscriber device 114 discussed with respect to FIG. 1, wherein, in the context of FIG. 3, Line A 316 corresponds to subscriber device 112 and Line B corresponds to subscriber device 114. In various examples, the routing proxy device 318 is alternatively a networked device that is not a routing proxy device, but which performs a similar function of routing and requesting the location of configuration data required to process a communication request.

Upon receiving the signal 300 comprising subject subscribers Line A and Line B, the routing proxy device 318 queries 302 the location server A 320 for Line A. In various examples, the routing proxy device 318 queries the location server A 320 for Line B and in various examples, Line A. In various examples, querying a location server for a subscriber corresponds to querying a location server for the location of configuration data associated with the subscriber.

The location server A 320 receives the query 302 for subscriber Line A, and, in response to determining that configuration data associated with the subscriber Line A is on a failed AS node of a clustered AS 322, determines a healthy AS node of the clustered AS 222. However, in contrast to FIG. 2, the location server A 320 is unable to request the healthy AS node to instantiate a configuration block containing configuration data associated with the subscriber line A and, in response to the configuration block containing configuration data associated with the subscriber line A being a child configuration block, additionally or alternatively a first parent configuration block upon which the child configuration block is dependent.

In various examples, the location server A 320 and the location server B 324 are allocated such that each location server is only able to instantiate configuration data on a subset of AS nodes of the AS 322. In various examples, the location server A 320 and the location server B 324 are geographically separated and are only able to instantiate configuration data on a subset of AS nodes located on hardware proximate to the location server. In various examples, at least one location server is comprised in the telecommunications network, such as one, two, four, five, thirty or any other number of location servers.

In response to the location server A 320 being unable to request the healthy AS node to instantiate desired configuration data, the location server A 320 sends a request 304 for the instantiation of configuration data associated with the subscriber line A to location server B 324 which is able to request the healthy AS node to instantiate the desired configuration data.

Location server B 324, upon receiving the instantiation request for configuration data associated with subscriber line A, requests 306 the healthy AS node to instantiate a configuration block containing configuration data associated with the subscriber line A and, in response to the configuration block containing configuration data associated with the subscriber line A being a child configuration block, a first parent configuration block upon which the child configuration block is dependent. This mirrors the method described with reference to FIG. 2. Location server B 324 receives a response 308 from the AS 322 that an identifier associated with the subscriber Line A has been registered on the healthy AS node, and subsequently duplicates 309 the response 310, forwarding the response 308 to location server A 320, which then responds 310 to the initial query 302 from the routing proxy device 318 with the location of the healthy AS node.

In various examples, location server B 324, after receiving the response 308 from the AS 322, adds at least one configuration block on the failed AS node, excluding any configuration block that was requested to be instantiated, to a queue for requesting the healthy AS node to instantiate each configuration block of the queue.

In various examples, instead of location server B 324 queuing configuration blocks, upon receiving the response 309 from location server B 324, location server A adds at least one configuration block on the failed AS node, excluding any configuration block that was requested to be instantiated, to a queue for requesting the healthy AS node to instantiate each configuration block of the queue.

It should be appreciated that the methods described with respect to FIG. 3, which relate to distributing the methods described with respect to FIG. 2 over multiple location servers, are in various examples applied to any number of location servers whenever a location server is unable to request a healthy AS node to instantiate desired configuration data.

In various examples, location server B 324, once all queues are clear of configuration blocks, sends a message to the AS 322 that instantiation is complete, and that AS 322 is not to expect further configuration block instantiation requests associated with the query 302. Request-response process 312 is illustrative of this completion message. In various examples, location server B 324, once all configuration blocks of a business group have been instantiated, sends a message to the AS 322 that instantiation is complete, and that AS 322 is not to expect further configuration block instantiation requests associated with the business group and, alternatively, associated with the query 302.

As described herein, the features of requesting a healthy AS node to instantiate a configuration block containing configuration data associated with a subscriber that is the subject of a received query and a parent configuration block if applicable, followed by the queuing of at least one remaining configuration block on the failed AS node, operate in an unconventional manner to achieve the efficient rehoming of configuration data and fast recovery of a communication request from AS node failure of configuration data located in a clustered AS of the disclosure, whilst maintaining the ability of the telecommunications network of the disclosure to facilitate communication requests. The features, of requesting a healthy AS node to instantiate a configuration block containing configuration data associated with a subscriber that is the subject of a received query and a parent configuration block if applicable, followed by the queuing of at least one remaining configuration block on the failed AS node, of the location server as described herein improve the function of the underlying computing device by enabling the efficient rehoming of configuration data located on nodes of a clustered AS of the disclosure and fast recovery from AS node failure whilst maintaining the ability of a telecommunications network in which the computing device is situated to facilitate communication requests.

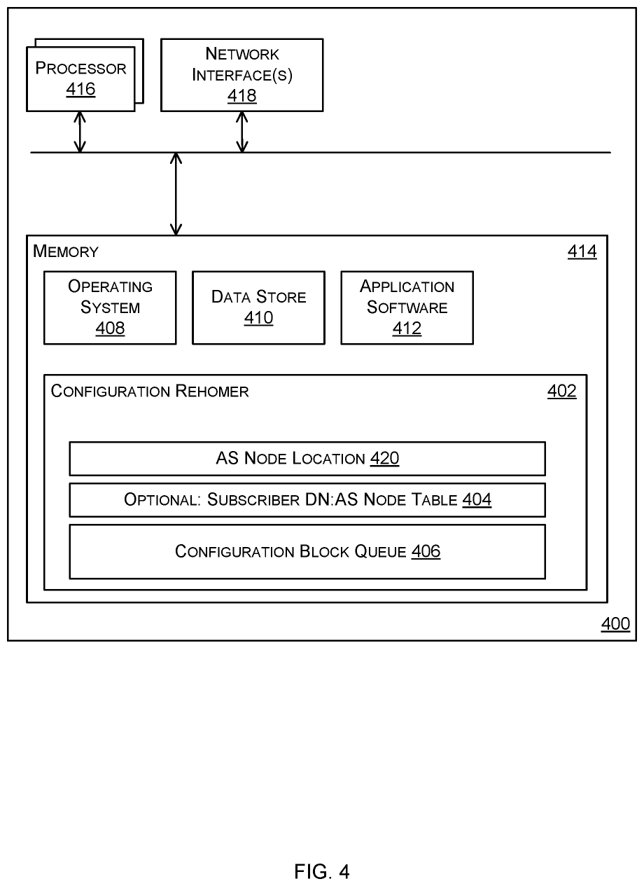

FIG. 4 illustrates various components of an exemplary computing-based device 400 which are implemented as any form of a computing and/or electronic device, and in which examples of a configuration rehomer corresponding to an entity with the functionality of a location server as described herein are implemented in some examples. In an example the computing-based device is a server or compute node in a data center or communications network.

Computing-based device 400 comprises one or more processors 416 which are microprocessors, controllers or any other suitable type of processors for processing computer executable instructions to control the operation of the device in order to carry out the methods described herein, including to efficiently rehome configuration data from a failed AS node of a telecommunications network whilst recovering quickly from AS node failure and maintaining the ability of the telecommunications network to process communication requests. In some examples, for example where a system on a chip architecture is used, the processors 416 include one or more fixed function blocks (also referred to as accelerators) which implement a part of the method of the configuration rehomer in hardware (rather than software or firmware). Platform software comprising an operating system 408 or any other suitable platform software is provided at the computing-based device to enable application software 412 to be executed on the device.

The computer executable instructions are provided using any computer-readable media that is accessible by computing based device 400. Computer-readable media includes, for example, computer storage media such as memory 414 and communications media. Computer storage media, such as memory 414, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 414) is shown within the computing-based device 400 it will be appreciated that the storage is, in some examples, distributed or located remotely and accessed via a network or other communication link (e.g. using network interface(s) 418).

A configuration rehomer 402 comprising a stored location of a AS node 420, optionally a stored table of subscriber identifier and associated AS node location 404, and at least one configuration block queue 406 are present at the computing-based device 400.

In various examples, the computing-based device 400 optionally comprises an input/output controller arranged to output display information to a display device which may be separate from or integral to the computing-based device 400. The display information may provide a graphical user interface. The input/output controller is also, in various examples, arranged to receive and process input from one or more devices, such as a user input device (e.g. a mouse, keyboard, camera, microphone or other sensor). In some examples the user input device detects voice input, user gestures or other user actions and provides a natural user interface (NUI). This user input may be used to change parameters of the method of the configuration rehomer. In an example, the display device also acts as the user input device if it is a touch sensitive display device. The input/output controller outputs data to devices other than the display device in some examples, e.g. a locally connected printing device.

Alternatively or in addition to the other examples described herein, examples include any combination of the following:

Clause A. A location server of a telecommunications network comprising a clustered Application Server, AS, the location server comprising:
at least one network interface;
a processor;
a memory storing instructions that, when executed by the processor, perform a method comprising:
   i) receive, via an interface of the at least one network interface, a query for a subscriber;
   in response to determining that configuration data associated with the subscriber is on a failed AS node of the clustered AS:
      determine a healthy AS node of the clustered AS;
      request, via an interface of the at least one network interface, the healthy AS node to instantiate a configuration block containing configuration data associated with the subscriber and, in response to the configuration block containing configuration data associated with the subscriber being a child configuration block, a first parent configuration block upon which the child configuration block is dependent;
      receive a response, via an interface of the at least one network interface, from the AS that an identifier, associated with the subscriber has been registered on the healthy AS node;
      respond, via an interface of the at least one network interface, to the query with the location of the healthy AS node;
   ii) after receiving the response from the AS, add at least one configuration block on the failed AS node, excluding any configuration block that was requested to be instantiated, to a queue for requesting the healthy AS node to instantiate each configuration block of the queue.

Clause B. The location server of clause A, wherein the at least one configuration block on the failed AS node added to the queue is any one or more of:
in response to a parent-child structure comprising the first parent configuration block, the parent-child structure comprising an additional parent configuration block, at least one additional parent configuration block including the root of the parent-child structure;
at least one child configuration block associated with any one or more of: the first parent configuration block, the at least one additional parent configuration block.

Clause C. The location server of clause A or clause C, the instructions executable to further iteratively request, via the at least one network interface, the healthy AS node to instantiate each configuration block of the queue.

Clause D. The location server of any preceding clause, wherein the queue is a first queue, the instructions further executable to at least one of: move a configuration block of the first queue to a second queue; move a configuration block of the second queue to the first queue, wherein each configuration block of the second queue is configured to be requested, via the at least one network interface, to be instantiated by the healthy AS node before any block of the first queue.

Clause E. The location server of clause D, wherein a configuration block of the first queue is moved to the second queue using a determined priority of the configuration block, wherein a higher priority configuration block is moved to the second queue before a lower priority configuration block, and wherein a configuration block of the second queue is moved to the first queue using a determined priority of the configuration block, wherein a lower priority configuration block is moved to the first queue before a higher priority block.

Clause F. The location server of any preceding clause, wherein a priority of a configuration block is determined by considering any one or more of: whether a subscriber associated with the configuration block is currently attempting to make a call via the telecommunications network, whether the configuration block is associated with configuration of a business group comprising subscribers, whether the configuration block has any dependencies, whether the configuration block is a dependency for another configuration block, a number of dependents of the configuration block, the priority of any dependents of the configuration block, a type of the configuration block, historical data regarding a subscriber associated with the configuration block, existence of a provisioning request for the block.

Clause G. The location server of any preceding clause, wherein a type of the configuration block is one of: line; Private Branch Exchange, PBX; multi-line hunt group.

Clause H. The location server of any preceding clause, the instructions executable to further:
in response to requesting the healthy AS node to instantiate a configuration block failing, reattempt to request the healthy AS node to instantiate the configuration block.

Clause I. The location server of any of clause A to clause G inclusive, the instructions executable to further:
in response to requesting the healthy AS node to instantiate a configuration block failing less than a predetermined number of times, reattempt to request the healthy AS node to instantiate the configuration block; and
in response to requesting the healthy AS node to instantiate a configuration block failing more than a predetermined number of times, add the configuration block to a failure queue, wherein each configuration block of the failure queue is configured to be requested to be instantiated after at least one other queue is clear of blocks.

Clause J. The location server of any preceding clause, wherein determining that configuration data associated with the subscriber is on a failed AS node comprises checking that a connection via the at least one network interface to a AS node of the clustered AS associated with the subscriber is unavailable.

Clause K. The location server of any preceding clause, wherein the AS registers subscriber identifiers with the location server such that the location server stores a table comprising, for each subscriber identifier, an associated location of a AS node of the AS upon which configuration data associated with the subscriber is stored.

Clause L. A method performed by a location server of a telecommunications network comprising a clustered Application Server, AS, the method comprising:
i) receiving a query for a subscriber;
in response to determining that configuration data associated with the subscriber is on a failed AS node of the clustered AS:
   determining a healthy AS node of the clustered AS;
   requesting the healthy AS node to instantiate a configuration block containing configuration data associated with the subscriber and, in response to the configuration block containing configuration data associated with the subscriber being a child configuration block, a first parent configuration block upon which the child configuration block is dependent;
   receiving a response from the AS that an identifier, associated with the subscriber has been registered on the healthy AS node;
   responding to the query with the location of the healthy AS node; and
   ii) after receiving the response from the AS, adding at least one configuration block on the failed AS node excluding any configuration block that was requested to be instantiated, to a queue for requesting the healthy AS node to instantiate each configuration block of the queue.

Clause M. The method of clause L, wherein the at least one configuration block on the failed AS node added to the queue is any one or more of:
in response to a parent-child structure comprising the first parent configuration block, the parent-child structure comprising an additional parent configuration block, at least one additional parent configuration block including the root of the parent-child structure;
at least one child configuration block associated with any one or more of: the first parent configuration block, the at least one additional parent configuration block.

Clause N. The method of any of clause L or clause M, further comprising iteratively requesting the healthy AS node to instantiate each configuration block of the queue.

Clause O. The method of any of clause L to clause N inclusive, wherein the queue is a first queue, further comprising at least one of: moving a configuration block of the first queue to a second queue; moving a configuration block of the second queue to the first queue, wherein each configuration block of the second queue is configured to be requested to be instantiated by the healthy AS node before any block of the first queue.

Clause P. The method of clause O, wherein a configuration block of the first queue is moved to the second queue using a determined priority of the configuration block, wherein a higher priority configuration block is moved to the second queue over a lower priority configuration block, and wherein a configuration block of the second queue is moved to the first queue using a determined priority of the configuration block, wherein a lower priority configuration block is moved to the first queue over a higher priority block.

Clause Q. The method of clause P, wherein the priority of a configuration block is determined by considering any one or more of: whether a subscriber associated with the configuration block is currently attempting to make a call via the telecommunications network, whether the configuration block is associated with configuration of a business group comprising subscribers, whether the configuration block has any dependencies, whether the configuration block is a dependency for another configuration block, a number of dependents of the configuration block, the priority of any dependents of the configuration block, a type of the configuration block, historical data regarding a subscriber associated with the configuration block, existence of a provisioning request for the block.

Clause R. The method of any of clause L to clause Q, wherein a type of the configuration block is one of: line; Private Branch Exchange, PBX; multi-line hunt group; or wherein receiving a query for a subscriber comprises: receiving the query as part of a communications flow; or receiving the query to read or change configuration of the subscriber as part of a provisioning flow.

Clause S. The method of any of clause L to clause R, further comprising:
receiving a first query for a subscriber as part of a communications flow and receiving a second query to read or change configuration of the subscriber or another subscriber as part of a provisioning flow.

Clause T. A method performed by a location server of a telecommunications network comprising a clustered Application Server, AS, wherein an entire configuration data of a business group is stored on a same node of the AS and wherein the entire configuration data of the business group is comprised of configuration blocks, at least one configuration block of the configuration blocks dependent upon another configuration block of the configuration blocks, the method comprising:
i) receiving a query for a subscriber of the business group corresponding to a subject of a communication request via the telecommunications network;
in response to determining that configuration data associated with the subscriber is on a failed AS node of the clustered AS:
   determining a healthy AS node of the clustered AS;
   requesting the healthy AS node to instantiate a parent configuration block and a child configuration block of the entire configuration data of the business group, wherein the parent configuration block contains configuration data of the business group, and wherein the child configuration block is dependent upon the parent configuration block and contains configuration data associated with the subscriber;
   receiving a response from the AS that an identifier, associated with the subscriber has been registered on the healthy AS node;
   responding to the query with the location of the healthy AS node; and
ii) after receiving the response from the AS, adding at least one configuration block associated with the entire configuration data of the business group, excluding the parent and the child configuration block that were requested to be instantiated, to a queue for requesting the healthy AS node to instantiate each configuration block of the queue.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one example or may relate to several examples. The examples are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various examples have been described above with a certain degree of particularity, or with reference to one or more individual examples, those skilled in the art could make numerous alterations to the disclosed examples without departing from the scope of this specification.

What is claimed is:

1. A location server communicatively coupled to a telecommunications network comprising a clustered Application Server (AS), the location server comprising:
at least one network interface;
a processor;
a memory storing instructions that, when executed by the processor, perform operations comprising:
receive, via an interface of the at least one network interface, a query for a subscriber;
in response to determining that a configuration associated with the subscriber is on a failed AS node of the clustered AS:
determine a healthy AS node of the clustered AS;
send a request, via an interface of the at least one network interface, for the healthy AS node to instantiate a configuration block containing configuration data associated with the subscriber; and
in response to the configuration block containing configuration data associated with the subscriber being a child configuration block, requesting instantiation of a first parent configuration block upon which the child configuration block is dependent;
receive a response, via the interface of the at least one network interface, from the AS indicative that an identifier, associated with the subscriber has been registered on the healthy AS node;
respond, via an interface of the at least one network interface, to the query with the location of the healthy AS node;
after receiving the response to the query from the AS, adding at least one configuration block on the failed AS node, excluding any configuration block that was requested to be instantiated, to a queue for requesting the healthy AS node to instantiate each configuration block of the queue.

2. The location server of claim 1, wherein the at least one configuration block on the failed AS node added to the queue is any one or more of:
a parent-child structure comprising the first parent configuration block;
at least one additional parent configuration block including a root of the parent-child structure;
the parent-child structure comprising the additional parent configuration block; or
at least one child configuration block associated with any one or more of the first parent configuration block or the at least one additional parent configuration block.

3. The location server of claim 1, the instructions executable to iteratively request, via the at least one network interface, the healthy AS node to instantiate each configuration block of the queue.

4. The location server of claim 1, wherein the queue is a first queue, the instructions further executable to at least one of:
move a configuration block of the first queue to a second queue; or
move a configuration block of the second queue to the first queue, wherein each configuration block of the second queue is configured to be requested, via the at least one network interface, to be instantiated by the healthy AS node before any block of the first queue.

5. The location server of claim 4, wherein a configuration block of the first queue is moved to the second queue using a determined priority of the configuration block, wherein a higher priority configuration block is moved to the second queue before a lower priority configuration block, and wherein a configuration block of the second queue is moved to the first queue using a determined priority of the configuration block, wherein a lower priority configuration block is moved to the first queue before a higher priority block.

6. The location server of claim 5, wherein the priority of a configuration block is determined based on one or more of:
whether a subscriber associated with the configuration block is currently attempting to make a call via the telecommunications network,
whether the configuration block is associated with configuration of a business group comprising subscribers,
whether the configuration block has any dependencies,
whether the configuration block is a dependency for another configuration block,
a number of dependents of the configuration block,
the priority of any dependents of the configuration block,
a type of the configuration block,
historical data regarding a subscriber associated with the configuration block, or
existence of a provisioning request for the block.

7. The location server of claim 6, wherein the type of the configuration block is one of: line; Private Branch Exchange, PBX; or multi-line hunt group.

8. The location server of claim 1, the instructions executable to further:
in response to requesting the healthy AS node to instantiate a configuration block failing, reattempt to request the healthy AS node to instantiate the configuration block.

9. The location server of claim 1, the instructions executable to further:
in response to requesting the healthy AS node to instantiate a configuration block failing less than a predetermined number of times, reattempt to request the healthy AS node to instantiate the configuration block; and
in response to requesting the healthy AS node to instantiate a configuration block failing more than a predetermined number of times, add the configuration block to a failure queue, wherein each configuration block of the failure queue is configured to be requested to be instantiated after at least one other queue is clear of blocks.

10. The location server of claim 1, wherein determining that the configuration data associated with the subscriber is on a failed AS node comprises checking that a connection via the at least one network interface to a AS node of the clustered AS associated with the subscriber is unavailable.

11. The location server of claim 1, wherein the AS registers subscriber identifiers with the location server such that the location server stores a table comprising, for each subscriber identifier, an associated location of a AS node of the AS upon which configuration data associated with the subscriber is stored.

12. A method performed by a location server of a telecommunications network comprising a clustered Application Server (AS), the method comprising:
receiving a query for a subscriber;
in response to determining that configuration data associated with the subscriber is on a failed AS node of the clustered AS:
determining a healthy AS node of the clustered AS;
requesting the healthy AS node to instantiate a configuration block containing configuration data associated with the subscriber and, in response to the configuration block containing configuration data associated with the subscriber being a child configuration block, requesting instantiation of a first parent configuration block upon which the child configuration block is dependent;
receiving a response from the AS that an identifier, associated with the subscriber, has been registered on the healthy AS node;
responding to the query with the location of the healthy AS node; and
after receiving the response from the AS, adding at least one configuration block on the failed AS node, excluding any configuration block that was requested to be instantiated, to a queue for requesting the healthy AS node to instantiate each configuration block of the queue.

13. The method of claim 12, wherein the at least one configuration block on the failed AS node added to the queue is any one or more of:
in response to a parent-child structure comprising the first parent configuration block, the parent-child structure comprising an additional parent configuration block, at least one additional parent configuration block including a root of the parent-child structure;
at least one child configuration block associated with any one or more of: the first parent configuration block, or the at least one additional parent configuration block.

14. The method of claim 12, further comprising iteratively requesting the healthy AS node to instantiate each configuration block of the queue.

15. The method of claim 12, wherein the queue is a first queue, further comprising at least one of: moving a configuration block of the first queue to a second queue; moving a configuration block of the second queue to the first queue, wherein each configuration block of the second queue is configured to be requested to be instantiated by the healthy AS node before any block of the first queue.

16. The method of claim 15, wherein a configuration block of the first queue is moved to the second queue using a determined priority of the configuration block, wherein a higher priority configuration block is moved to the second queue over a lower priority configuration block, and wherein a configuration block of the second queue is moved to the first queue using a determined priority of the configuration block, wherein a lower priority configuration block is moved to the first queue over a higher priority block.

17. The method of claim 16, wherein the priority of a configuration block is determined by considering any one or more of: whether a subscriber associated with the configuration block is currently attempting to make a call via the telecommunications network, whether the configuration block is associated with configuration of a business group comprising subscribers, whether the configuration block has any dependencies, whether the configuration block is a dependency for another configuration block, a number of dependents of the configuration block, the priority of any dependents of the configuration block, a type of the configuration block, historical data regarding a subscriber associated with the configuration block, existence of a provisioning request for the block.

18. The method of claim 12, wherein receiving a query for a subscriber comprises: receiving the query as part of a communications flow; or receiving the query to read or change configuration of the subscriber as part of a provisioning flow.

19. The method of claim 12, comprising:
receiving a first query for a subscriber as part of a communications flow and receiving a second query to read or change configuration of the subscriber or another subscriber as part of a provisioning flow.

20. A method performed by a location server of a telecommunications network comprising a clustered Application Server (AS), wherein an entire configuration data of a business group is stored on a same node of the AS and wherein the entire configuration data of the business group is comprised of configuration blocks, at least one configuration block of the configuration blocks dependent upon another configuration block of the configuration blocks, the method comprising:
receiving a query for a subscriber of the business group corresponding to a subject of a call via the telecommunications network;
in response to determining that configuration data associated with the subscriber is on a failed AS node of the clustered AS:
determining a healthy AS node of the clustered AS;
requesting the healthy AS node to instantiate a parent configuration block and a child configuration block of the entire configuration data of the business group, wherein the parent configuration block contains configuration data of the business group, and wherein the child configuration block is dependent upon the parent configuration block and contains configuration data associated with the subscriber;
receiving a response from the AS that an identifier, associated with the subscriber has been registered on the healthy AS node;
responding to the query with the location of the healthy AS node; and
after receiving the response from the AS, adding at least one configuration block associated with the entire configuration data of the business group, excluding the parent and the child configuration block that were requested to be instantiated, to a queue for requesting the healthy AS node to instantiate each configuration block of the queue.
